(19) United States
(12) Patent Application Publication
(10) Pub. No.: US 2026/0142972 A1
(43) Pub. Date: May 21, 2026

(54) CONFIGURABLE AUTHENTICATION SYSTEM

(71) Applicant: Bank of America Corporation, Charlotte, NC (US)

(72) Inventor: Patricia Anne Gillis, Chicago, IL (US)

(21) Appl. No.: 18/950,552

(22) Filed: Nov. 18, 2024

(51) Int. Cl. H04L 9/40

(52) U.S. Cl. CPC H04L 63/0861; H04L 63/0876; H04L 2463/082

(57) ABSTRACT

A configurable authentication system is provided. The configurable authentication system authenticates a client user interacting with a web application. The client user may perform an initial authentication to access the web application. Upon authentication, the web application may initiate an active time, in which the client user is actively interfacing with the web application. The web application may detect a period of inactivity, in which the client user does not provide input into the web application. Upon completion of a predetermined amount of inactive time, access to the web application may expire. The configurable authentication system may provide a grace period. The grace period may bridge a gap between an active time and a dormant time. During the dormant time, the client user may be completely logged off of the application. During the grace period, the client user may resume active access of the web application with limited authentication.

### FIELD OF TECHNOLOGY

Aspects of the disclosure relate to authentication systems.

### BACKGROUND OF THE DISCLOSURE

Recently, many businesses interface with clients using one or more web-based applications. Each of these applications typically require authentication processes to authenticate the client user. Conventionally, complicated applications, costly applications and high-security applications involve more complex authentication processes than simplified applications, inexpensive applications and low-security applications.

Such complex authentication processes may involve two factor authentication processes. An authentication factor is a category of evidence that a person has to present to prove they are who they purport to be. The categories of evidence include something you know, something you have and something you are. Examples of something you know may be a password or personal identification number (“PIN”). Examples of something you have may be a one-time password (“OTP”) sent via SMS (short message service) to a mobile device. Entry of the SMS may prove that the submitter is in possession of the mobile device. Examples of something you are may include a biometric identifier, such as a fingerprint, an iris scan or a face scan.

Additionally, in high-security applications, the authenticated session of a client user may expire after a relatively brief time period of inactivity. Upon expiration of the authenticated session, any open projects or open files that have not been saved or completed may be deleted. Expiration of the authenticated session may disturb client users that interact with the high security applications. Furthermore, expiration of the authenticated session may delete open projects and open files.

Therefore, it would be desirable to create a configurable authentication system. Such a configurable authentication system may provide a predefined grace period. The predefined grace period may, for a predefined time period after the session expiration, provide preferably short-term storage capabilities and reduce authentication requirements for a client user.

### SUMMARY OF THE DISCLOSURE

A configurable authentication system is provided. The configurable authentication system may augment the authentication systems within a system network.

The configurable authentication system may pacify the annoyance that users of the network system encounter when the users are closed-out of the system for inactivity. The system may close out a user's session when the user is inactive for greater than a predetermined time period. This may occur when a user is inactive at an application operating on the system network. The time period may be five minutes.

The configurable authentication system may provide a predefined grace period. The grace period may be two minutes, five minutes, seven minutes or any other suitable time period. The grace period may bridge the gap between active time of an application and dormant time of an application. Active time of an application may be a time period in which a user is actively engaging with an application or completely logged into the application. Dormant time of an application may be a time period in which a user is completely logged off the application. It should be noted that the user may remain a registered user of the application during the dormant time.

A comprehensive level of authentication may involve entry of a password and entry of a one-time password (“OTP”) or token. An intermediate level of authentication may involve determining that a comprehensive level of authentication was established within a predetermined time period. The intermediate level may also involve identifying entry of the password and confirming that the request for the intermediate level of authentication was transmitted from the same device that the comprehensive level of authentication was established. Confirmation that the request for the intermediate level of authentication was the same as the comprehensive level of authentication may involve confirming a match between the internet protocol (“IP”) address of the initial device to the IP address of the subsequent device, confirming a match between the detected geolocation of the initial device and the detected geolocation of the subsequent device, confirming a match between the detected device identifier of the initial device and the detected device identifier of the subsequent device and/or any other suitable confirmation matches.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIGS. 3A and 3B show a prior art hybrid diagram;

FIGS. 4A and 4B show an illustrative hybrid diagram in accordance with principles of the disclosure;

FIG. 5 shows an illustrative flow chart in accordance with principles of the disclosure;

FIG. 6 shows another illustrative flow chart in accordance with principles of the disclosure; and

FIG. 7 shows yet another illustrative flow chart in accordance with principles of the disclosure.

### DETAILED DESCRIPTION OF THE DISCLOSURE

Systems, apparatus and methods for re-authenticating a client user on a configurable authentication system are provided.

The system may include a web-based graphical user interface. The web-based graphical user interface may operate on a first hardware processor and a first hardware memory. The web-based graphical user interface may receive an authentication request from a client user. The client user may operate on a second hardware processor and a second hardware memory. The web-based graphical user interface may communicate the authentication request to a dynamic authentication system. The dynamic authentication system may operate on the first hardware processor and the first hardware memory.

The dynamic authentication system may receive the authentication request. Upon receipt of the authentication request, the dynamic authentication system may generate an authentication attempt. The authentication attempt may include a request for verification of two or more authentication factors from the client user. At least one of the two or more authentication factors may be via an authentication channel that bypasses the web-based graphical user interface. As such, at least one of the authentication factors may verify the client user at a device different from the device used to communicate with the web-based graphical user interface.

The dynamic authentication system may verify the two or more authentication factors. Upon an unsuccessful verification attempt, the dynamic authentication system may communicate the unsuccessful verification to the web-based graphical user interface. The web-based graphical user interface may prevent the unverified client user from accessing an application at the web-based graphical user interface.

Upon a successful verification attempt, the dynamic authentication system may successfully verify the two or more authentication factors. The dynamic authentication system may authenticate the client user based on the successful verification of the two or more authentication factors. The dynamic authentication system may transmit an electronic instruction to the web-based graphical user interface. The electronic instruction may direct the web-based graphical user interface to instantiate an authenticated session with the client user.

In response to receipt of the electronic instruction, the web-based graphical user interface may instantiate the authenticated session with the client user. The authenticated session may involve the client user interfacing with a secure application on the web-based graphical user interface. The web-based graphical user interface may receive one or more unsaved electronic inputs from the client user. The electronic inputs may include keystrokes, mouse clicks or any other suitable electronic inputs. The web-based graphical user interface may display one or more unsaved electronic outputs. The electronic outputs may include alphanumeric text, graphical icons, symbols and/or any other suitable electronic outputs.

The web-based graphical user interface may detect a period of inactivity following receipt of the inputs. Upon detection of the inactivity, the web-based graphical user interface may store a format of a display of the web-based graphical user interface, the one or more unsaved inputs and the one or more unsaved outputs in a memory location within the first hardware memory. Storing the format, the unsaved inputs and the unsaved outputs may include capturing a screenshot of the display and/or capturing the contents of a short-term computer memory. A short-term computer memory may be memory that is used to receive the contents of a display, however, once the display is terminated, the contents of the short-term memory may be permanently deleted. As such, storing the format, the unsaved inputs and the unsaved outputs may involve the storing the format, the unsaved inputs and the unsaved outputs in a long-term hardware memory. Such a long-term hardware memory may maintain the stored data unless the data is permanently deleted.

Upon storing the format, the unsaved inputs and the unsaved outputs, the web-based graphical user interface may terminate the display of the web-based graphical user interface. The web-based graphical user interface may receive a request for re-instantiation of the authenticated session by the client user. The request for re-instantiation may be transmitted from the second processor.

In response to receipt of the request for re-instantiation, the web-based graphical user interface may request one factor of authentication from the client user. The one factor of authentication may include receipt of a password, a personal identification number (“PIN”) or a biometric input.

The web-based graphical user interface may receive the one factor of authentication from the client user. In response to receiving the one factor of authentication from the client user, the web-based graphical user interface may authenticate the client user and re-instantiate the authenticated session. The web-based graphical user interface may format the display of the web-based user interface with the stored format. The web-based graphical user interface may display the one or more unsaved inputs and the one or more unsaved outputs on the display of the web-based user interface.

Upon receipt of the request for re-instantiation of the authenticated session, the web-based graphical user interface may communicate with the dynamic authentication system to verify that a device transmitting the request for re-instantiation is the same device as a device that initiated the authenticated session.

The dynamic authentication system may verify that the device transmitting the request is the same device as the device that initiated the authentication session by verification of a correspondence between an internet protocol (“IP”) address associated with the device transmitting the request for re-instantiation and an IP address of the device that initiated the authenticated session.

The dynamic authentication system may verify that the device transmitting the request is the same device as the device that initiated the authentication session by verification of a correspondence between a device identifier associated with the device transmitting the request for re-instantiation and a device identifier of the device that initiated the authenticated session.

The dynamic authentication system may verify that the device transmitting the request is the same device as the device that initiated the authentication session by verification of a correspondence between a detected geolocation of the device transmitting the request for re-instantiation and a detected geolocation of the device that initiated the authenticated session.

Methods for re-authenticating a client user on a configurable authentication system are provided. Methods may include receiving an authentication request from a client user. The request may be received at a web-based graphical user interface. The web-based graphical user interface may operate on a first hardware processor and a first hardware memory. The client user may operate on a second hardware processor and a second hardware memory. As such, network protocols may be used to enable communication between the client user and the web-based graphical user interface. The network protocols may enable communication between a client user, operating on a computing device, and a web-based graphical user interface, displayed on the client user's computing device and hosted on a processor remote from the client user.

Methods may include communicating the authentication request from the web-based graphical user interface to a dynamic authentication system operating on the first hardware processor and the first hardware memory.

Methods may also include receiving the authentication request at the dynamic authentication system. Upon receipt of the authentication request, methods may include generating an authentication attempt. The authentication attempt may include requesting verification of two or more authentication factors from the client user. Verification of at least one of the two or more authentication factors may be via an authentication channel that bypasses the web-based graphical user interface.

Methods may include successfully verifying the two or more authentication factors. One or more of the authentication factors may include an alphanumerical character set input by the client user. Such an alphanumerical character set may be referred to as a password, passcode and/or personal identification number (“PIN”). One or more of the authentication factors may include verification of possession of a device. The device may be a mobile device, a radio frequency identification (“RFID”) device or any other suitable device. One or more of the authentication factors may include a biometric identifier.

Methods may include authenticating the client user based on the successful verification of the two or more authentication factors. Methods may include instantiating an authenticated session between the client user and the web-based graphical user interface. The authenticated session may be based on, or as a result of, the authenticating.

Methods may include receiving, at the web-based graphical user interface, one or more unsaved inputs from the client user. Methods may include displaying one or more unsaved outputs on the web-based graphical user interface.

Following the receiving the input, methods may include detecting a period of inactivity. The period of inactivity may be defined as lack of input from the client user for a predetermined time period.

Methods may include initiating a grace period on the web-based graphical user interface. The grace period may bridge a gap between an active period and a dormant period.

Upon detection of the lack of activity, methods may include storing a format of the web-based graphical user interface, the one or more unsaved inputs and the one or more unsaved outputs in a memory location within the first hardware memory.

At times, the grace period may complete without a request for re-instantiation from the client user. In such embodiments, methods may include permanently deleting the format of the web-based graphical user interface, the one or more unsaved inputs and the one or more unsaved outputs from the memory location within the first hardware memory.

Also, at times, prior to completion of the grace period, methods may include receiving a request for re-instantiation of the authenticated session by the client user. The request for re-instantiation may be transmitted from the second processor. In response to request for re-instantiation, methods may include requesting one factor of authentication from the client user at the web-based graphical user interface. Methods may include authenticating the client user directly via the web-based graphical user interface. Methods may also include re-instantiating the authenticated session. Methods may also include formatting the web-based graphical user interface with the format including the one or more unsaved inputs and the one or more unsaved outputs.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

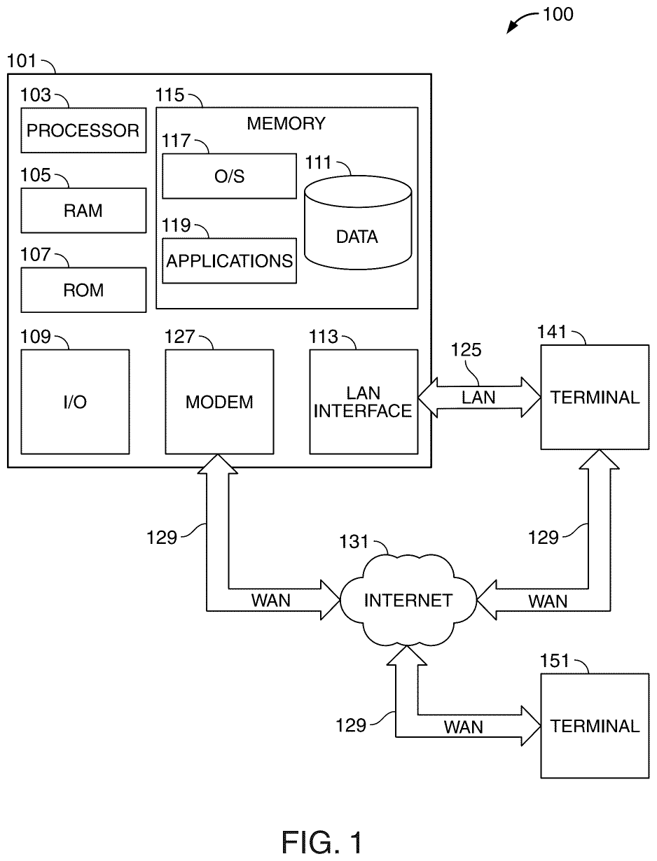

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

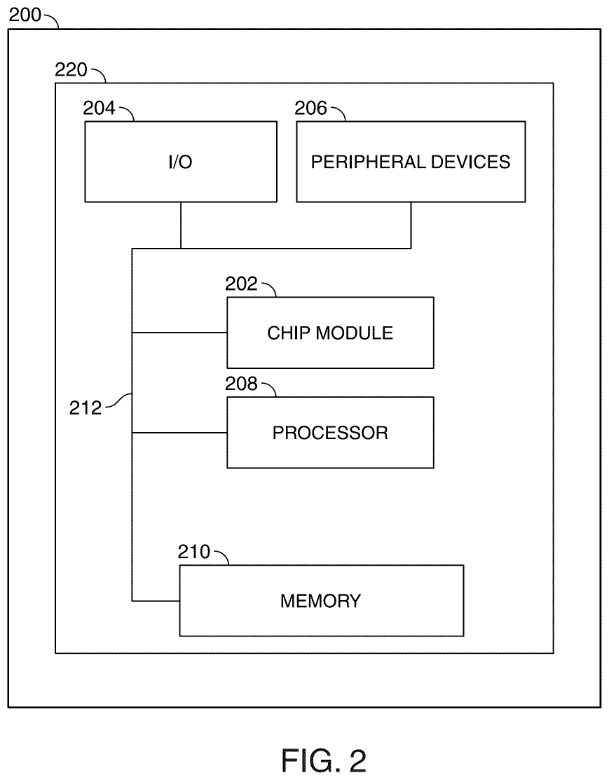

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

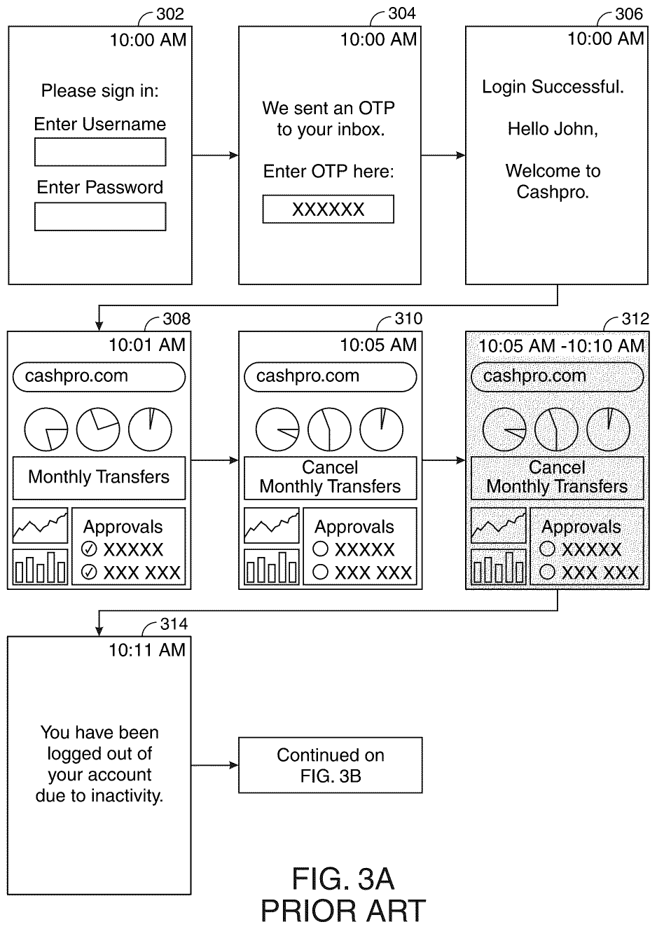

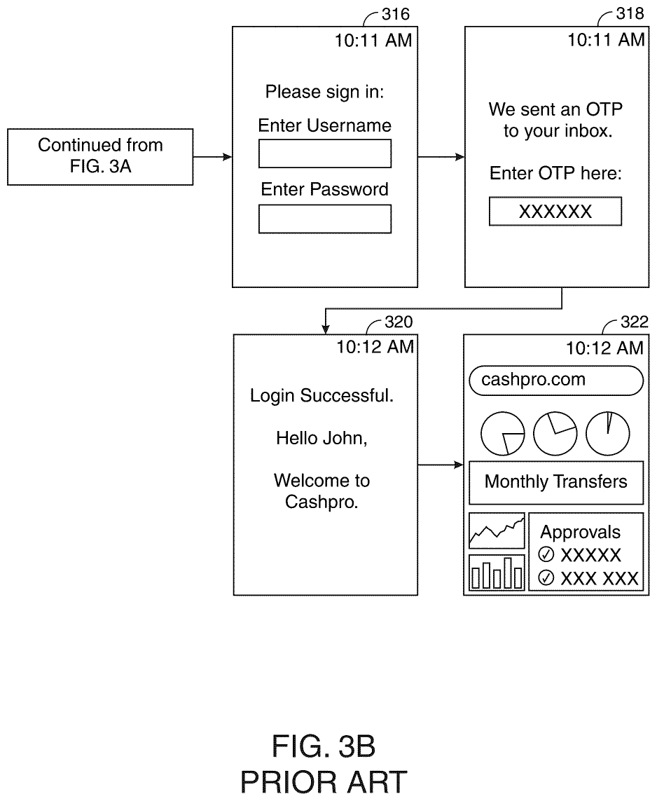

FIGS. 3A and 3B show a prior art hybrid flow diagram. As shown at 302, a user initiates a sign-on request of a web-based application at 10:00 AM. The application requests identity credentials from the user. The identity credentials include a username and a password. Upon receipt of the identity credentials, a one-time password (“OTP”) or token is transmitted to an inbox associated with the user. The application requests entry of the OTP, as shown at 304. Upon receipt of the correct OTP, the application successfully logs the user into the application, as shown at 306. Successful login is at 10:00 AM, within a minute of the initial sign-on request.

The user interacts with the application at 10:01 AM, as shown at 308. The user also interacts with the application at 10:05 AM, as shown at 310. Interacting with the application may involve unchecking the boxes within the approvals widget. Between 10:05 AM and 10:10 AM, the user becomes occupied with another application, or any other suitable activity, as indicated by the grayed out background shown at 312. Upon completion of an inactivity period of five minutes, the application terminates the application for the user, as shown at 314. It should be noted that upon termination of the application, all pending activities within the application are deleted.

At 10:11 AM, the user attempts to perform additional activities and/or complete the pending activities on the application. However, the user is unable to perform actions within the application. The user has been signed out of the application and all pending activities have been deleted. As such, the user is required to re-enter the identity credentials, as shown at 316, receive a new OTP and reenter the OTP into the application, as shown at 318. The second login is successful as shown at 320. However, all pending activities have been deleted, as shown at 322. As shown at 322, the checkboxes on approvals widget are checked (the interaction of the user unchecking the boxes has been deleted).

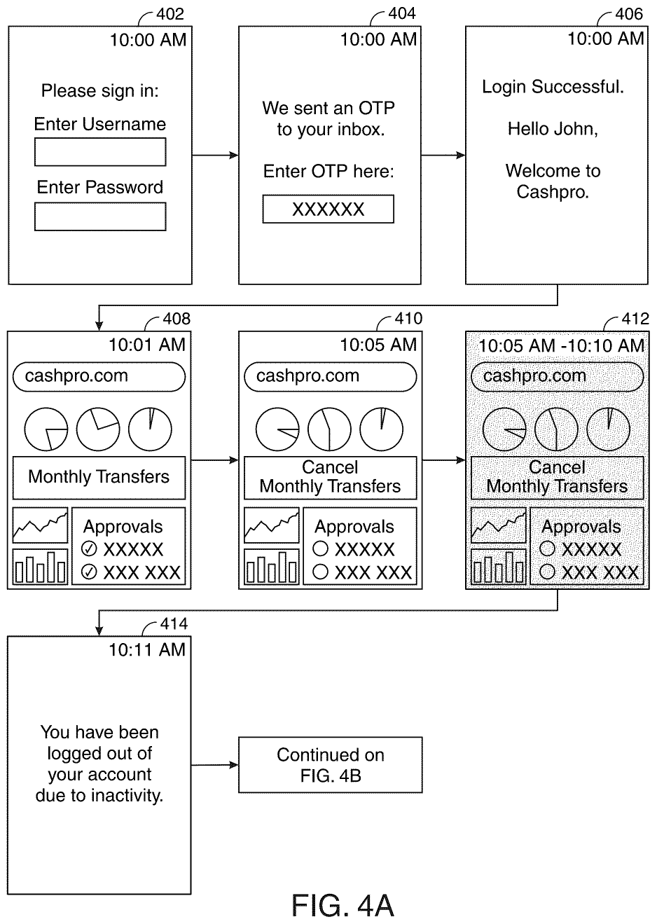

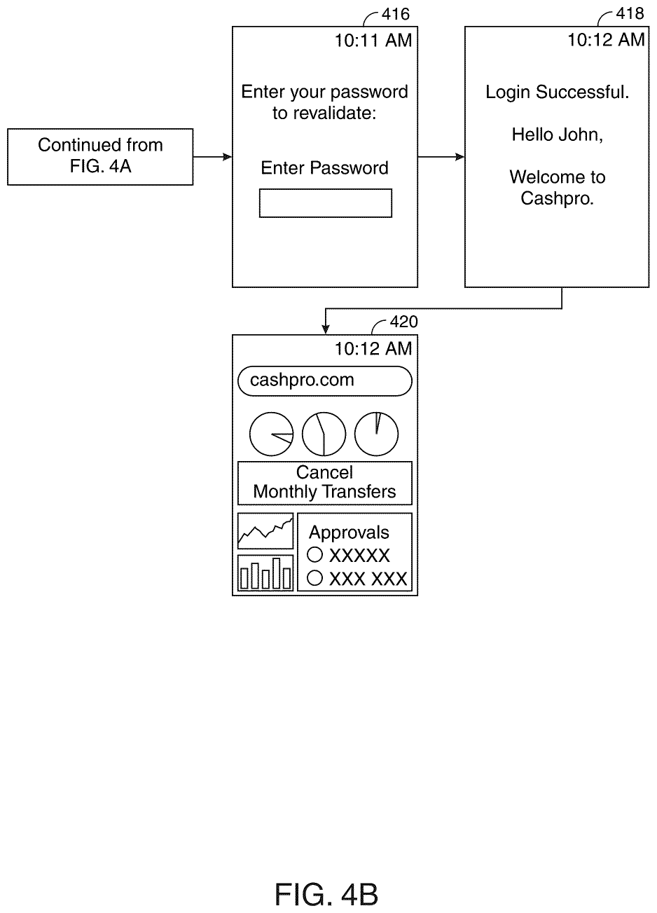

FIGS. 4A and 4B show a hybrid flow diagram. As shown at 402, a user may initiate a sign-on request on a web-based application at 10:00 AM. The application requests identity credentials from the user. The identity credentials may include a username and a password. Upon receipt of the identity credentials, an OTP or token is transmitted to an inbox associated with the user. The application may request entry of the OTP, as shown at 404. Upon receipt of the correct OTP, the application may successfully log the user into the application, as shown at 406. Successful login may be at 10:00 AM, within a minute of the initial sign-on request.

The user may interact with the application at 10:01 AM, as shown at 408. The user may also interact with the application at 10:05 AM, as shown at 410. Interacting with the application may involve unchecking the boxes within the approvals widget. Between 10:05 AM and 10:10 AM, the user may become occupied with another application, or any other suitable activity, as indicated by the grayed out background shown at 412. Upon completion of an inactivity period of five minutes, the application may place a hold on the application, as shown at 414. It should be noted that, for a predetermined time period after the hold has been placed on the application, the session may be suspended, and pending activities and/or works in progress may be stored in an associated memory. As such, if the user reestablished communication with the application before the predetermined hold time period is completed, the user may be able to access the pending activities and/or works in progress.

Furthermore, the user may be able to enter a single factor of authentication in order to revalidate the identity credentials at the application. As such, identity verification screen 416 includes request for password entry. It should be noted that the identity verification screen does not request username or OTP entry. Upon receipt of a correct password, the identity of the user may be verified, as shown at 418. Upon completion of a successful login, the application may open the pending activities and/or works in progress, as shown at 10:12 AM. As such, the checkboxes remain unchecked. Additionally, the application may reformat itself to match look and feel preferences previously set by the user. Examples of look and feel preferences may include placement of various widgets within the application, font size of various widgets within the application, maximizing various widgets within the application and minimizing various widgets within the application.

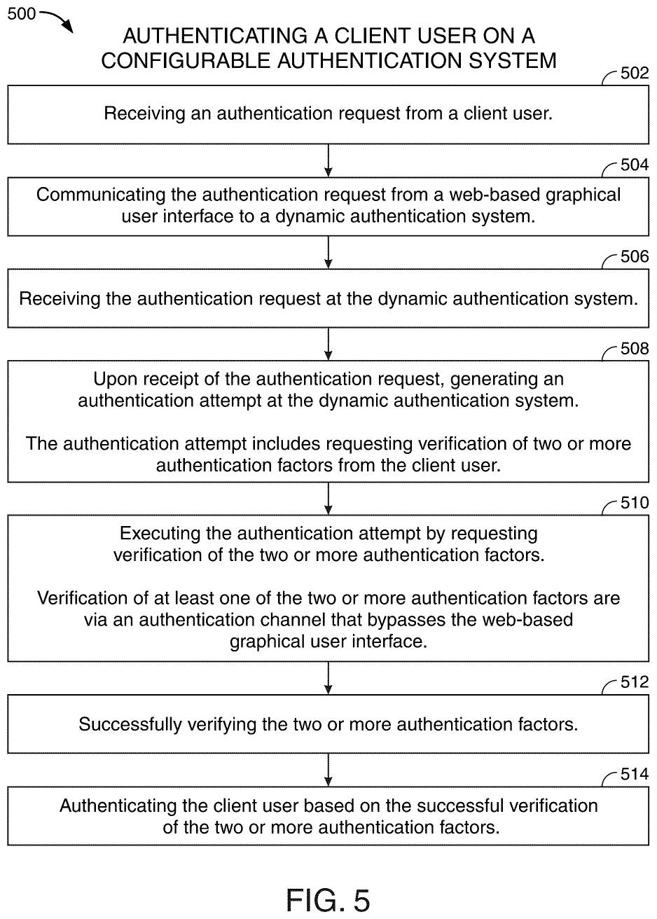

FIG. 5 shows illustrative flow chart 500 for authenticating a client user on a configurable authentication system. Step 502 shows receiving an authentication request from a client user. The request may be received at a web-based application, a mobile application or any other suitable virtual or physical location.

Step 504 shows communicating the authentication request from a web-based graphical user interface to a dynamic authentication system. The dynamic authentication system may be situated behind the web-based graphical user interface. The dynamic authentication system may receive the authentication request, as shown at 506.

Upon receipt of the authentication request, the dynamic authentication system may generate an authentication attempt, as shown at 508. The authentication attempt may include requesting verification of two or more authentication factors from the client user.

The authentication attempt may be executed by the dynamic authentication system, as shown at 510. As such, the authentication attempt may include requesting verification of the two or more authentication factors. Verification of at least one of the two or more authentication factors may be via an authentication channel that bypasses the web-based graphical user interface. As such, the authentication channels may provide a direct communication link between a device associated with the user and the dynamic authentication system.

Step 512 shows successful verification of the two or more authentication factors. Step 514 shows authenticating the client user based on the successful verification of the two or more authentication factors.

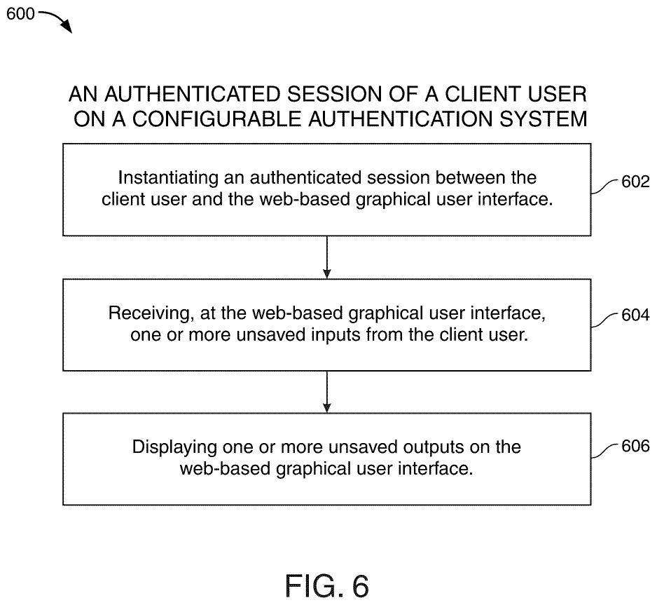

FIG. 6 shows illustrative flow chart 600 for an authenticated session of a client user on a configurable authentication system. Step 602 shows instantiating an authenticated session between the client user and the web-based graphical user interface. Step 604 shows receiving, at the web-based graphical user interface, one or more unsaved inputs from the client user. Step 606 shows displaying one or more unsaved outputs on the web-based graphical user interface.

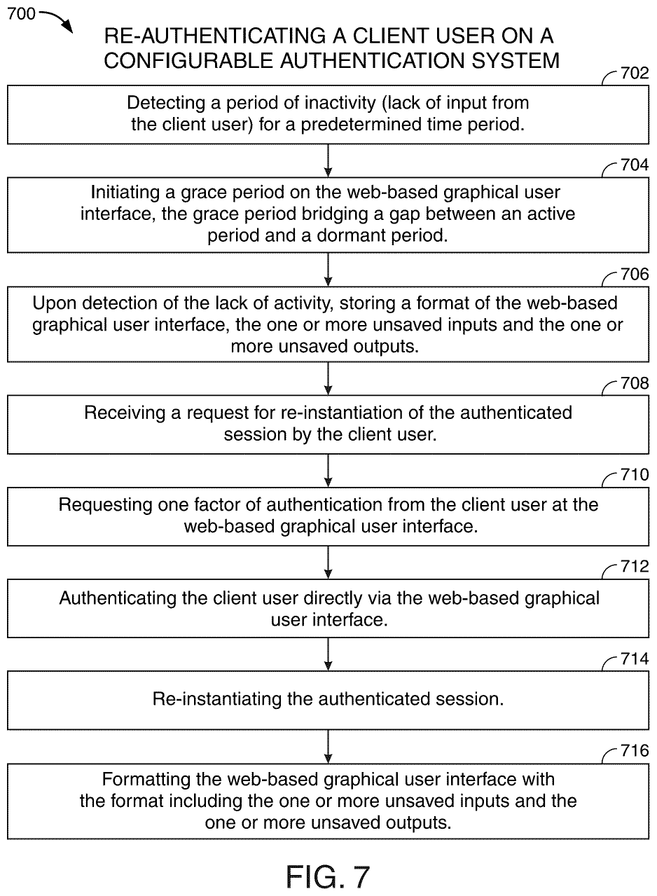

FIG. 7 shows illustrative flow chart 700 for re-authenticating a client user on a configurable authentication system. Step 702 shows detecting a period of inactivity for a predetermined time period. A period of inactivity may be categorized as lack of input from the client user.

Step 704 shows initiating a grace period on the web-based graphical user interface. The grace period may bridge the gap between an active period and a dormant period. Step 706 shows upon detection of the lack of activity, storing a format of the web-based graphical user interface, the one or more unsaved inputs and the one or more unsaved outputs.

Step 708 shows receiving a request for re-instantiation of the authenticated session by the client user. Step 710 shows requesting one factor of authentication from the client user at the web-based graphical user interface. Step 712 shows authenticating the client user directly via the web-based graphical user interface. Step 714 shows re-instantiating the authenticated session. Step 716 shows formatting the web-based graphical user interface with the format including the one or more unsaved inputs and the one or more unsaved outputs.

Thus, methods and apparatus for a CONFIGURABLE AUTHENTICATION SYSTEM are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for re-authenticating a client user on a configurable authentication system, the method comprising:
receiving, at a web-based graphical user interface operating on a first hardware processor and a first hardware memory, an authentication request from a client user, said client user operating on a second hardware processor and a second hardware memory;
communicating the authentication request from the web-based graphical user interface to a dynamic authentication system operating on the first hardware processor and the first hardware memory;
receiving the authentication request at the dynamic authentication system;
upon receipt of the authentication request, generating an authentication attempt, said authentication attempt comprising requesting verification of two or more authentication factors from the client user, wherein verification of at least one of the two or more authentication factors are via an authentication channel that bypasses the web-based graphical user interface;
successfully verifying the two or more authentication factors;
authenticating the client user based on the successful verification of the two or more authentication factors;
instantiating an authenticated session between the client user and the web-based graphical user interface based on the authenticating;
receiving, at the web-based graphical user interface, one or more unsaved inputs from the client user;
displaying one or more unsaved outputs on the web-based graphical user interface;
following the receiving of the input, detecting a period of inactivity comprising lack of input from the client user for a predetermined time period;
initiating a grace period on the web-based graphical user interface, the grace period bridging a gap between an active period and a dormant period;
upon detection of the lack of activity, storing a format of the web-based graphical user interface, the one or more unsaved inputs and the one or more unsaved outputs in a memory location within the first hardware memory;
prior to completion of the grace period, receiving a request for re-instantiation of the authenticated session by the client user, said request for re-instantiation transmitted from the second processor;
requesting one factor of authentication from the client user at the web-based graphical user interface;
authenticating the client user directly via the web-based graphical user interface;
re-instantiating the authenticated session; and
formatting the web-based graphical user interface with the format including the one or more unsaved inputs and the one or more unsaved outputs.

2. The configurable authentication system of claim 1 wherein one of the two or more authentication factors includes an alphanumerical character set input by the client user.

3. The configurable authentication system of claim 1 wherein one of the two or more authentication factors include verification of possession of a device.

4. The configurable authentication system of claim 3 wherein the device is a mobile device.

5. The configurable authentication system of claim 3 wherein the device is a radio frequency identification (“RFID”) device.

6. The configurable authentication system of claim 1 wherein one of the two or more authentication factors includes a biometric identifier.

7. The configurable authentication system of claim 1 further comprising, upon receiving the request for the re-instantiation of the authenticated session by the client user, verifying that a device transmitting the request for re-instantiation is the same device as a device that initiated the authenticated session.

8. The configurable authentication system of claim 7 wherein the verifying the device transmitting the request for re-instantiation includes verifying that an internet protocol (“IP”) address associated with the device transmitting the request for re-instantiation is the same IP address as an IP address of the device that initiated the authenticated session.

9. The configurable authentication system of claim 7 wherein the verifying the device transmitting the request for re-instantiation includes verifying that a device identifier associated with the device transmitting the request for re-instantiation is the same device identifier as a device identifier of the device that initiated the authenticated session.

10. The configurable authentication system of claim 7 wherein the verifying the device transmitting the request for re-instantiation includes verifying that a detected geolocation of the device transmitting the request for re-instantiation is the same detected geolocation as a detected geolocation of the device that initiated the authenticated session.

11. A system for re-authenticating a client user on a configurable authentication system, the system comprising:
a web-based graphical user interface operating on a first hardware processor and a first hardware memory, the web-based graphical user interface operable to:
receive an authentication request from a client user operating on a second hardware processor and a second hardware memory;
communicate the authentication request to a dynamic authentication system operating on the first hardware processor and the first hardware memory;
the dynamic authentication system operable to:
upon receipt of the authentication request, generate an authentication attempt, said authentication attempt comprising a request for verification of two or more authentication factors from the client user, wherein the verification of at least one of the two or more authentication factors are via an authentication channel that bypasses the web-based graphical user interface;
successfully verifies the two or more authentication factors; and
authenticates the client user based on the successful verification of the two or more authentication factors; and
transmits an electronic instruction to the web-based graphical user interface to instantiate an authenticated session with the client user;
the web-based graphical user interface further operable to:
instantiate the authenticated session with the client user in response to receipt of the electronic instruction;
receive one or more unsaved electronic inputs from the client user;
display one or more unsaved electronic outputs;
detect a period of inactivity following receipt of the inputs;
upon detection of the inactivity, store a format of a display of the web-based graphical user interface, the one or more unsaved inputs and the one or more unsaved outputs in a memory location within the first hardware memory;
terminate the display of the web-based graphical user interface;
receive a request for re-instantiation of the authenticated session by the client user, the request for re-instantiation transmitted from the second processor;
request one factor of authentication from the client user;
receive one factor of authentication from the client user;
authenticate the client user and re-instantiate the authenticated session;
format the display with the stored format; and
display the one or more unsaved inputs and the one or more unsaved outputs.

12. The system of claim 11 wherein, upon receipt of the request for re-instantiation of the authenticated session, the web-based graphical user interface communicates with the dynamic authentication system to verify that a device transmitting the request for re-instantiation is the same device as a device that initiated the authenticated session.

13. The system of claim 12 wherein dynamic authentication system verifies that the device transmitting the request is the same device as the device that initiated the authentication session by verification of a correspondence between an internet protocol (“IP”) address associated with the device transmitting the request for re-instantiation and an IP address of the device that initiated the authenticated session.

14. The system of claim 12 wherein dynamic authentication system verifies that the device transmitting the request is the same device as the device that initiated the authentication session by verification of a correspondence between a device identifier associated with the device transmitting the request for re-instantiation and a device identifier of the device that initiated the authenticated session.

15. The system of claim 12 wherein dynamic authentication system verifies that the device transmitting the request is the same device as the device that initiated the authentication session by verification of a correspondence between a detected geolocation of the device transmitting the request for re-instantiation and a detected geolocation of the device that initiated the authenticated session.

16. A method for re-authenticating a client user on a configurable authentication system, the method comprising:
receiving, at a web-based graphical user interface operating on a first hardware processor and a first hardware memory, an authentication request from a client user, said client user operating on a second hardware processor and a second hardware memory;
communicating the authentication request from the web-based graphical user interface to a dynamic authentication system operating on the first hardware processor and the first hardware memory;
receiving the authentication request at the dynamic authentication system;
upon receipt of the authentication request, generating an authentication attempt, said authentication attempt comprising requesting verification of two or more authentication factors from the client user, wherein verification of at least one of the two or more authentication factors are via an authentication channel that bypasses the web-based graphical user interface;
successfully verifying the two or more authentication factors;
authenticating the client user based on the successful verification of the two or more authentication factors;
instantiating an authenticated session between the client user and the web-based graphical user interface based on the authenticating;
receiving, at the web-based graphical user interface, one or more unsaved inputs from the client user;
displaying one or more unsaved outputs on the web-based graphical user interface;
following the receiving of the input, detecting a period of inactivity comprising lack of input from the client user for a predetermined time;
initiating a grace period on the web-based graphical user interface, the grace period bridging a gap between an active period and a dormant period;
upon detection of the lack of activity, storing a format of the web-based graphical user interface, the one or more unsaved inputs and the one or more unsaved outputs in a memory location within the first hardware memory;
completing the grace period on the web-based user interface; and
permanently deleting the format of the web-based graphical user interface, the one or more unsaved inputs and the one or more unsaved outputs from the memory location within the first hardware memory.

17. The configurable authentication system of claim 16 wherein one of the two or more authentication factors includes an alphanumerical character set input by the client user.

18. The configurable authentication system of claim 16 wherein one of the two or more authentication factors include verification of possession of a device.

19. The configurable authentication system of claim 16 wherein one of the two or more authentication factors includes a biometric identifier.
